(19) United States
(12) Patent Application Publication
(10) Pub. No.: US 2021/0204020 A1
(43) Pub. Date: Jul. 1, 2021

(54) TRANSMITTING DEVICE, RECEIVING DEVICE, TRANSMITTING METHOD, AND RECEIVING METHOD FOR MULTIMEDIA DATA

(71) Applicant: SHENZHEN LENKENG TECHNOLOGY CO., LTD, Shenzhen (CN)

(72) Inventor: Binghai GAO, Shenzhen (CN)

(73) Assignee: SHENZHEN LENKENG TECHNOLOGY CO., LTD, Shenzhen (CN)

(21) Appl. No.: 17/035,784

(22) Filed: Sep. 29, 2020

(30) Foreign Application Priority Data
Dec. 31, 2019 (CN) 201911413808.1
Dec. 31, 2019 (CN) 201922471355.X

(51) Int. Cl. H04N 21/4363; H04N 21/2347; H04N 21/647

(52) U.S. Cl. CPC H04N 21/43637; H04N 21/64707; H04N 21/2347

(57) ABSTRACT

This application discloses a transmitting device, a receiving device, a transmitting method, and a receiving method for multimedia data. The transmitting device includes a HDMI, a first compression module, a first encapsulation module, and a first 5G communication module. The HDMI is configured to obtain multimedia data; the first compression module is configured to compress the multimedia data to obtain code stream data; the first encapsulation module is configured to encapsulate the code stream data through a communication protocol to obtain a protocol data stream; the first 5G communication module is configured to transmit the protocol data stream; and the HDMI, the first compression module, the first encapsulation module, and the first 5G communication modules are connected in sequence, and the first 5G communication module is configured to communicate with the receiving device. By adopting this application, the transmission rate of multimedia data can be increased to realize high-definition video playback without delay.

### CROSS REFERENCE TO RELATED APPLICATION

The present application claims priority to Chinese Patent Application Serial No. 201911413808.1 on 31 Dec. 2019, and Chinese Patent Application Serial No. 201922471355.X on 31 Dec. 2019, the disclosures of both of which are herein by incorporated by reference.

### TECHNICAL FIELD

The disclosure relates to the technical field of video transmission, and in particular to a transmitting device, a receiving device, a transmitting method, and a receiving method for multimedia data.

### BACKGROUND

At present, people are increasingly demanding video quality, and ultra-high-definition video is universally popular. However, the existing ultra-high-definition video usually requires expensive HDMI cables for transmission, which is unfriendly to long-distance transmission.

### SUMMARY

Based on the above problems and the shortcomings of the prior art, a transmitting device, a receiving device, a transmitting method, and a receiving method for multimedia data are provided according to implementation of the disclosure. On one hand, the wiring cost required for transmission can be saved, and on the other hand, the transmission rate of multimedia data can be increased to achieve high-definition video playback without delay.

In a first aspect, a device for transmitting multimedia data is provided. The device includes:

a high definition multimedia interface (HDMI), a first compression module, a first encapsulation module, and a first 5th-Generation (5G) communication module, where

the HDMI is configured to obtain multimedia data. The first compression module is configured to compress the multimedia data to obtain code stream data. The first encapsulation module is configured to encapsulate the code stream data through a communication protocol to obtain a protocol data stream. The first 5G communication module is configured to transmit the protocol data stream. The HDMI, the first compression module, the first encapsulation module, and the first 5G communication modules are connected in sequence.

In a second aspect, a receiving device for multimedia data is provided. The device includes

a second 5G communication module, a second decapsulation module, a second decompression module, and a HDMI.

The second 5th-Generation (5G) communication module is configured to receive a protocol data stream. The second decapsulation module is configured to decapsulate the protocol data stream from the second 5G communication module to obtain specific code stream data. The second decompression module is configured to decompress the specific code stream data to obtain specific multimedia data. The HDMI is configured to output the specific multimedia data. The second 5G communication module, the second decapsulation module, the second decompression module, and the HDMI are connected in sequence.

In a third aspect, a transmitting method for multimedia data is provided. The method includes the following.

Multimedia data obtained is encoded, with a compression algorithm, to obtain code stream data.

The code stream data is encapsulated through a communication protocol to obtain a protocol data stream.

The protocol data stream is transmitted to a first 5G communication module.

The protocol data stream is transmitted, by the first 5G communication module, to a receiving device, where the receiving device is any one of the foregoing receiving devices.

In a fourth aspect, a receiving method for multimedia data is provided. The method includes the follows.

A protocol data stream transmitted by a transmitting device is obtained from a second 5G communication module, where the transmitting device is any one of the foregoing transmitting devices.

The protocol data stream is decapsulated, through a communication protocol, to obtain specific code stream data. And

the specific code stream data is decoded, with a decompression algorithm, to obtain specific multimedia data.

The beneficial effect of the disclosure is as follows. The compressed multimedia data is encapsulated into a protocol data stream. The protocol data stream is transmitted, through a 5G communication module, to other device based on MIMO technology. On one hand, the disclosure can save the wiring costs required for transmission, and on the other hand, can increase the transmission rate of multimedia data to achieve high-definition video playback without delay.

### BRIEF DESCRIPTION OF THE DRAWINGS

In order to explain the technical solutions in implementations of the disclosure more clearly, the accompanying drawings used in the description of the embodiments are briefly introduced below. Obviously, the accompanying drawings in the following description are some implementations of the disclosure. For ordinary technicians, other accompanying drawings can be obtained based on these accompanying drawings without paying creative work.

FIG. 1 is a schematic structural diagram of a transmitting device according to the present application.

FIG. 2 is another schematic structural diagram of the transmitting device according to the present application.

FIG. 3 is another schematic structural diagram of the transmitting device according to the present application.

FIG. 4 is another schematic structural diagram of the transmitting device according to the present application.

FIG. 5 is another schematic structural diagram of the transmitting device according to the present application.

FIG. 6 is another schematic structural diagram of the transmitting device according to the present application.

FIG. 7 is a schematic structural diagram of a receiving device according to the present application.

FIG. 8 is another schematic structural diagram of the receiving device according to the present application.

FIG. 9 is another schematic structural diagram of the receiving device according to the present application.

FIG. 10 is another schematic structural diagram of the receiving device according to the present application.

FIG. 11 is another schematic structural diagram of the receiving device according to the present application.

FIG. 12 is another schematic structural diagram of the receiving device according to the present application.

FIG. 13 is a schematic flow chart of a transmitting method for multimedia data according to the present application.

FIG. 14 is a schematic diagram of transmission scenario for the multimedia data according to the present application.

FIG. 15 is another schematic diagram of transmission scenario for the multimedia data according to the present application.

FIG. 16 is another schematic diagram of transmission scenario for the multimedia data according to the present application.

FIG. 17 is another schematic diagram of transmission scenario for the multimedia data according to the present application.

FIG. 18 is a schematic flow chart of a receiving method for the multimedia data according to the present application.

FIG. 19 is another schematic diagram of transmission scenario for the multimedia data according to the present application.

FIG. 20 is another schematic diagram of transmission scenario for the multimedia data according to the present application.

FIG. 21 is another schematic diagram of transmission scenario for the multimedia data according to the present application.

FIG. 22 is another schematic diagram of transmission scenario for the multimedia data according to the present application.

FIG. 23 is another schematic structural diagram of the transmitting device according to the present application.

FIG. 24 is another schematic structural diagram of the receiving device according to the present application.

### DETAILED DESCRIPTION

The technical solutions in the disclosure will be described clearly and completely in combination with the accompanying drawings in the disclosure. Obviously, the described implementations are part of the implementations of the disclosure, but not all of the implementations.

FIG. 1 is a schematic structural diagram of a transmitting device for multimedia data according to the disclosure. As shown in FIG. 1, the transmitting device 10 may include, but is not limited to, a HDMI 100, a first compression module 101, a first encapsulation module 102, and a first 5G communication module 103. The HDMI 100, the first compression module 101, the first encapsulation module 102, and the first 5G communication module 103 are connected in sequence via cables.

The HDMI 100 is configured to obtain multimedia data.

The multimedia data may include, but is not limited to, perception media data such as text, data, sound, graphics, images, or videos (such as 1080P, 4K or 8K resolution, high-definition video with frame rate 60FPS), representation media data such as telegram code or bar code etc. It should be noted that the multimedia data includes one or more different types of video source data (such as surveillance video, promotional video, cartoon, costume drama or modern urban drama), which are not limited in implementations of the disclosure. The multimedia data may further include, but is not limited to, the following characteristics: a sampling format of YUV/YCbCr with 4:4:4, and High Dynamic Range Imaging (HDR).

The first compression module 101 is configured to compress the multimedia data to obtain code stream data.

The first encapsulation module 102 is configured to encapsulate the code stream data through a communication protocol to obtain a protocol data stream.

The first 5G communication module 103 is configured to transmit the protocol data stream. The first 5G communication module 103 may include, but is not limited to, a peripheral component interconnect expresses (PCIE) interface, a Gigabit Ethernet interface, a 10G Ethernet interface, a USB 3.0 interface, a RS232 interface, and the like.

The first compression module 101 may be specifically configured to:

encode the multimedia data inputted via the HDMI 100 with a compression algorithm to obtain the code stream data.

The compression algorithm may include, but is not limited to:

a display stream compression (DSC) algorithm, a color space converter (CSC) or a JPEG2000 compression algorithm.

The first encapsulation module 102 may be specifically configured to:

encapsulate the code stream data through a user datagram protocol (UDP) to obtain the protocol data stream in the form of a UDP data packet;

or

encapsulate the code stream data through an internet protocol (IP) to obtain the protocol data stream in the form of an IP data packet;

or

encapsulate the code stream data through a specific communication protocol to obtain the protocol data stream in a specific data packet format.

The first 5G communication module 103 may be specifically configured to execute as follows.

1: the protocol data stream is transmitted to a receiving device.

2: the protocol data stream is transmitted to a first receiving device and a second receiving device respectively.

3: the protocol data stream is transmitted to a base station, and the protocol data stream is forwarded to a receiving device by the base station.

4: the base station includes a first base station and a second base station.

The protocol data stream is transmitted to the first base station, is forwarded to the second base station by the first base station, and is transmitted to a receiving device by the second base station.

According to implementations of the disclosure, the transmitting device 10 is communicatively connected to a receiving device by the first 5G communication module 103, which can increase the transmission rate of multimedia data and realize delay-free transmission of high-definition videos.

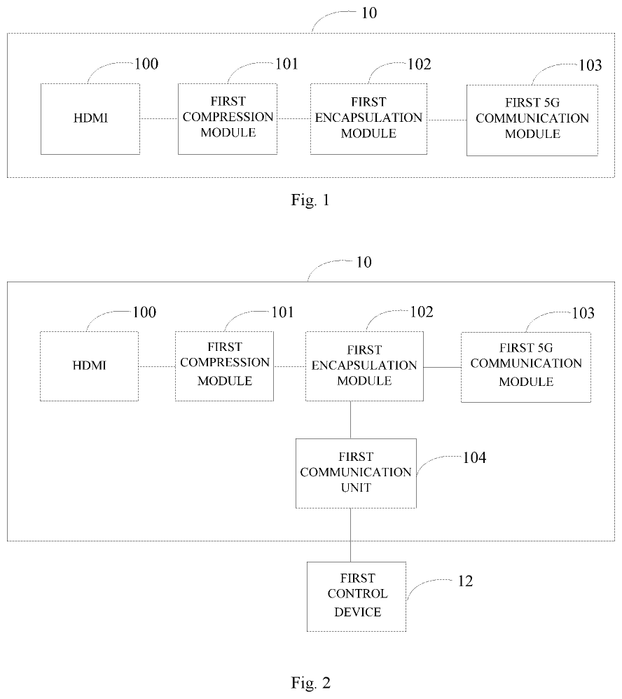

FIG. 2 is another schematic structural diagram of transmitting device for multimedia data according to the present application. As shown in FIG. 2, the transmitting device 10 includes the HDMI 100, the first compression module 101, the first encapsulation module 102, and the first 5G communication module 103, and may further include a first communication unit 104.

It should be noted that the first communication unit 104 is connected to a first control device 12.

The first communication unit 104 may include, but is not limited to, a USB interface and a RS232 interface.

The transmitting device 10 may be connected, via the USB interface or the RS232 interface, to the first control device 12 such as a mouse or a keyboard.

That is to say, the transmitting device 10 may receive, by means of the mouse or the keyboard via the USB interface or the RS232 interface, a control instruction inputted by a user.

The first encapsulation module 102 may be specifically configured to:

encapsulate a control instruction obtained from the first control device 12 via the first communication unit 104 and the code stream data outputted by the first compression module 101, to obtain the protocol data stream.

Optionally, the first encapsulation module 102 may be specifically configured to:

encapsulate the control instruction obtained from the first control device 12 through the first communication unit 104 to obtain the protocol data stream.

It should be noted that the transmitting device 10 may transmit, by the first 5G communication module 103, the protocol data stream encapsulated with the control instruction to the receiving device. The receiving device may obtain, based on the protocol data stream received, the control instruction to execute a corresponding control function, such as controlling a display device connected to the receiving device to start up, shut down, or adjust screen brightness, etc.

It should be noted that the transmitting device 10 may also obtain, by the first 5G communication module 103, the protocol data stream from the receiving device, obtain control information according to the protocol data stream, and perform, through the control information, a corresponding control function, such as controlling a video source device connected to the transmitting device 10 to start up, shut down, or switch the video playback content, etc.

It can be understood that related definitions and descriptions not provided in implementations of FIG. 2 and specific implementation of functional components included in the transmitting device 10 of FIG. 2 can be referred to the implementations of FIG. 1 and will not be repeated herein.

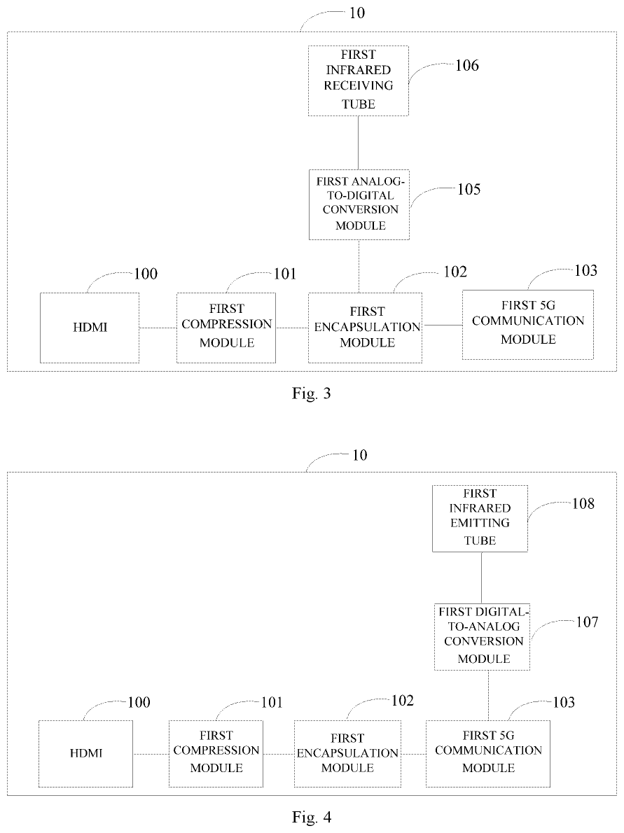

FIG. 3 is another schematic structural diagram of transmitting device for multimedia data according to the implementation. As shown in FIG. 3, in addition to including the HDMI 100, the first compression module 101, the first encapsulation module 102, and the first 5G communication module 103, the transmitting device 10 may further include a first analog-to-digital conversion module 105 and a first infrared receiving tube 106.

The first infrared receiving tube 106 may be configured to receive an infrared signal (control information) transmitted by a first remote controller, and process the infrared signal to obtain a first signal. The first signal may include, but is not limited to, an infrared light signal. The first signal is configured to control a display device.

The first analog-to-digital conversion module 105 is configured to perform analog-to-digital conversion on the first signal received by the first infrared receiving tube 106, and obtain a first digital signal by sampling the first signal.

The first encapsulation module 102 may be specifically configured to encapsulate the first digital signal with code stream data to obtain a protocol data stream and control a display device to such as start up, shut down, or adjust screen brightness, etc.

It should be noted that the transmitting device 10 may transmit, by the first 5G communication module 103, the protocol data stream encapsulated with the first digital signal and code stream data to a receiving device. The receiving device may obtain, according to the received protocol data stream, corresponding control information and perform a corresponding control function, such as controlling a video source to start up, shut down, or switch video playback content, etc.

It can be understood that related definitions and descriptions not provided in implementations of FIG. 3 and specific implementations of the functional components included in the transmitting device 10 of FIG. 3 can be referred to the implementations of FIG. 1 and will not be repeated herein.

Referring to FIG. 4, it is another schematic structural diagram of transmitting device for multimedia data according to implementations of the disclosure. As shown in FIG. 4, in addition to including the HDMI 100, the first compression module 101, the first encapsulation module 102, and the first 5G communication module 103, the transmitting device 10 may further include a first digital-to-analog conversion module 107 and a first infrared emitting tube 108.

It should be noted that the transmitting device 10 further includes a first decapsulation module.

The first decapsulation module is specifically configured to decapsulate protocol data stream received, through the first 5G communication module 103, from a receiving device to obtain a second digital signal.

The first digital-to-analog conversion module 107 is specifically configured to convert the second digital signal to obtain a second analog signal according to which the transmitting device controls the first infrared emitting tube 108 to emit a second signal. The second signal is configured to control a video source device communicatively connected to the transmitting device 10. For example, the second signal according to which the transmitting device controls a video source device (such as a camera, a DVD, a notebook computer, or a set-top box, etc.) to start up, shut down, or switch video playback content.

The second signal may include, but is not limited to, an infrared light signal.

It can be understood that related definitions and descriptions not provided in implementations of FIG. 4 and specific implementations of the functional components included in the transmitting device 10 of FIG. 4 can be referred to the implementation of FIG. 1 and will not be repeated herein.

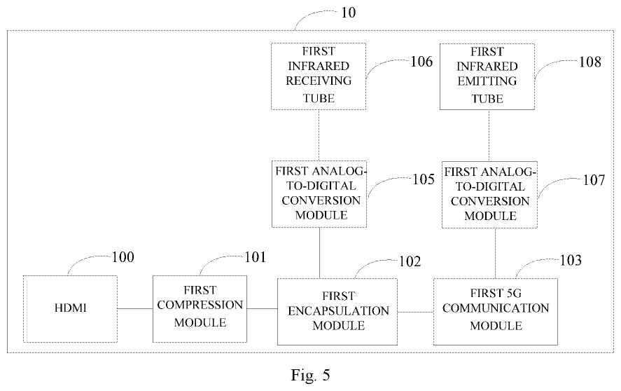

FIG. 5 is another schematic structural diagram of transmitting device for multimedia data according to implementations of the disclosure. As shown in FIG. 5, in addition to including the HDMI 100, the first compression module 101, the first encapsulation module 102, and the first 5G communication module 103, the transmitting device 10 may further include the first analog-to-digital conversion module 105, the first infrared receiving tube 106, the first digital-to-analog conversion module 107, and the first infrared emitting tube 108.

It can be understood that related definitions and descriptions not provided in implementations of FIG. 5 and specific implementations of functional components included in the transmitting device 10 of FIG. 5 can be referred to implementations of FIG. 3 and FIG. 4 and will not be repeated herein.

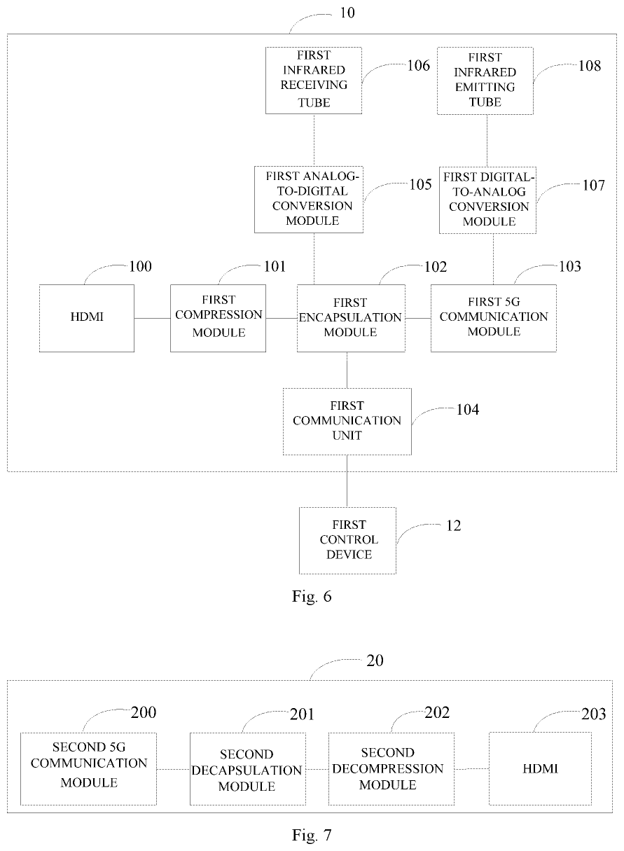

FIG. 6 is another schematic structural diagram of transmitting device for multimedia data according to the present application. As shown in FIG. 6, in addition to including the HDMI 100, the first compression module 101, the first encapsulation module 102, and the first 5G communication module 103, the transmitting device 10 may further include the first analog-to-digital conversion module 105, the first infrared receiving tube 106, the first digital-to-analog conversion module 107, the first infrared emitting tube 108, and the first communication unit 104.

It can be understood that related definitions and descriptions not provided in implementations of FIG. 6 and specific implementations of functional components included in the transmitting device 10 of FIG. 6 can be referred to implementations described in FIGS. 1-5 and will not be repeated herein.

FIG. 7 is a schematic structural diagram of receiving device for multimedia data according to the present application. As shown in FIG. 7, the receiving device 20 may include, but is not limited to, a second 5G communication module 200, a second decapsulation module 201, a second decompression module 202, and a HDMI 203. The second 5G communication module 200, the second decapsulation module 201, the second de-compression module 202, and the HDMI 203 are connected in sequence via cables.

The second 5G communication module 200 may be specifically configured to execute as follows.

1: a protocol data stream is received from a transmitting device.

2: the transmitting device includes a first transmitting device and a second transmitting device.

The protocol data stream includes a first protocol data stream and a second protocol data stream.

The first protocol data stream is received from the first transmitting device and the second protocol data stream is received from the second transmitting device.

3: a protocol data stream forwarded by a base station is received, where the protocol data stream is received by the base station from the transmitting device.

4: after a protocol data stream is received by a third base station from a transmitting device and is forwarded by the third base station to a fourth base station, the receiving device receive the protocol data stream forwarded by the fourth base station.

It should be noted that the second 5G communication module 200 may include, but is not limited to, a peripheral component interconnect expresses (PCIE) interface, a Gigabit Ethernet interface, a 10G Ethernet interface, a USB 3.0 interface, a RS232 interface, and the like.

The second decapsulation module 201 may be configured to execute as follows.

If the protocol data stream is a protocol data stream in the form of a UDP data packet, the receiving device 20 may decapsulate the protocol data stream through a UDP to obtain specific code stream data.

If the protocol data stream is a protocol data stream in the form of an IP data packet, the receiving device 20 may decapsulate the protocol data stream through an IP to obtain specific code stream data.

If the protocol data stream is a protocol data stream in the form of a specific data packet, the receiving device 20 may decapsulate the protocol data stream through a specific communication protocol to obtain specific code stream data.

The second decompression module 202 may be configured to execute as follows.

If multimedia data is encoded, with a DSC compression algorithm, by the transmitting device to obtain code stream data, the specific code stream data is decoded with a DSC decompression algorithm to obtain specific multimedia data.

If multimedia data is encoded, with a CSC, by the transmitting device to obtain code stream data, the specific code stream data, with the CSC, is decoded to obtain specific multimedia data.

If multimedia data is encoded, with a JPEG2000 compression algorithm, by the transmitting device to obtain code stream data, the specific code stream data is decoded, with a JPEG2000 decompression algorithm, to obtain specific multimedia data.

The HDMI 203 may be configured to output specific multimedia data decoded by the second decompression module 202 to a display device connected to the receiving device 20, where the display device is used for displaying the specific multimedia data.

In summary, the receiving device 20 receives a protocol data stream through the second 5G module 200, processes the protocol data stream to obtain specific multimedia data, and outputs the specific multimedia data to a display device (such as a display) for displaying or playing, where the display device is connected to the receiving device 20.

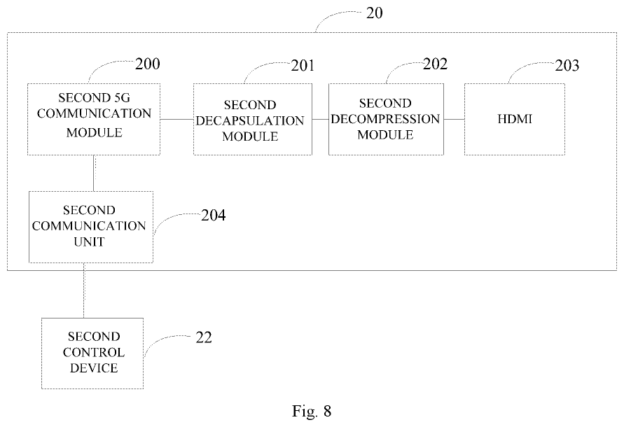

FIG. 8 is another schematic structural diagram of receiving device for multimedia data according to the present application. As shown in FIG. 8, in addition to including the second 5G communication module 200, the second decapsulation module 201, the second decompression module 202, and the HDMI 203, the receiving device 20 may further include a second communication unit 204.

It should be noted that the second communication unit 204 is connected to a second control device 22.

The second communication unit 204 may include, but is not limited to, a USB interface and a RS232 interface.

The receiving device 20 may be connected, through the USB interface or the RS232 interface, to the second control device 22 such as a mouse or a keyboard.

That is, the receiving device 20 may receive, via the USB interface or the RS232 interface, a control instruction inputted, by means of the mouse or the keyboard, by a user.

It should be noted that the receiving device 20 further includes a second encapsulation module connected to the second communication unit 204.

The second encapsulation module is configured to encapsulate a control instruction to obtain a protocol data stream, where the protocol data stream is obtained, by the second communication unit 204, from the second control device.

It should be noted that the receiving device 20 receives, by the second communication unit 204, a control instruction from the second control device, encapsulates the control instruction by the second encapsulation module to obtain a protocol data stream, and transmits, by the second 5G module 200, the protocol data stream to a transmitting device. Then the transmitting device obtains control information according to the protocol data stream, and performs, based on the control information, a corresponding control function, such as controlling a video source device to start up, shut down, and switch video playback content.

It can be understood that related definitions and descriptions not provided in implementations of FIG. 8 and specific implementations of the functional components included in the receiving device 20 of FIG. 8 can be referred to implementations of FIG. 7 and will not be repeated herein.

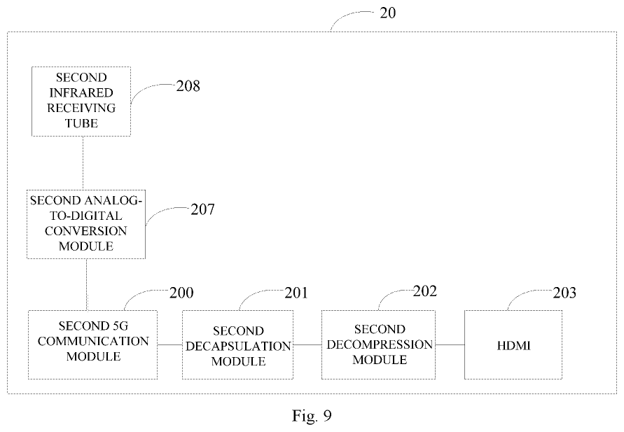

FIG. 9 is another schematic structural diagram of receiving device for multimedia data according to the present application. As shown in FIG. 9, in addition to including the second 5G communication module 200, the second decapsulation module 201, the second decompression module 202, and the HDMI 203, the receiving device 20 may further include a second infrared receiving tube 208 and a second analog-to-digital conversion module 207.

The second analog-to-digital conversion module 207 is configured to perform analog-to-digital conversion on a third signal received by the second infrared receiving tube 208 to obtain a third digital signal, where the third signal may be an infrared light signal.

The receiving device 20 further includes a second encapsulation module.

The second encapsulation module may be specifically configured to encapsulate the third digital signal to obtain a protocol data stream.

It should be noted that the receiving device 20 may transmit, by the second 5G communication module 200, the protocol data stream encapsulated with the third digital signal to a transmitting device. The transmitting device may obtain, by the transmitting device, corresponding control information based on the protocol data stream received from the receiving device 20 and perform, based on the corresponding control information, a corresponding control function, such as controlling a video source device to start up, shut down, etc.

It can be understood that related definitions and descriptions not provided in implementations of FIG. 9 and specific implementations of the functional components included in the receiving device 20 of FIG. 9 can be referred to the implementations of FIG. 7 and will not be repeated herein.

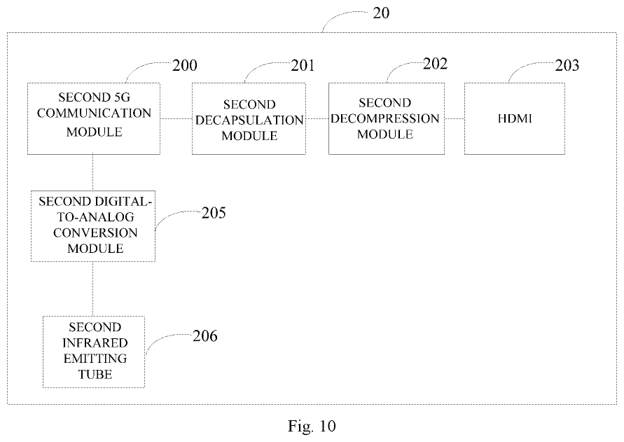

FIG. 10 is another schematic structural diagram of receiving device for multimedia data according to the present application. As shown in FIG. 10, in addition to including the second 5G communication module 200, the second decapsulation module 201, the second decompression module 202, and the HDMI 203, the receiving device 20 may further include a second digital-to-analog conversion module 205 and a second infrared emitting tube 206.

The second decapsulation module 201 may be configured to decapsulate the protocol data stream received, by the second 5G communication module 200, from a transmitting device to obtain a fourth digital signal.

The second digital-to-analog conversion module 205 is configured to perform digital-to-analog conversion on the fourth digital signal to obtain a fourth analog signal.

The fourth analog signal according to which the receiving device 20 controls the second infrared emitting tube 206 to emit a fourth signal. For example, the fourth signal according to which the display device adjusts the volume of a display device.

The fourth signal may include, but is not limited to, an infrared light signal.

It can be understood that related definitions and descriptions not provided in implementations of FIG. 10 and specific implementations of the functional components included in the receiving device 20 of FIG. 10 can be referred to the implementations of FIG. 7, which will not be repeated herein.

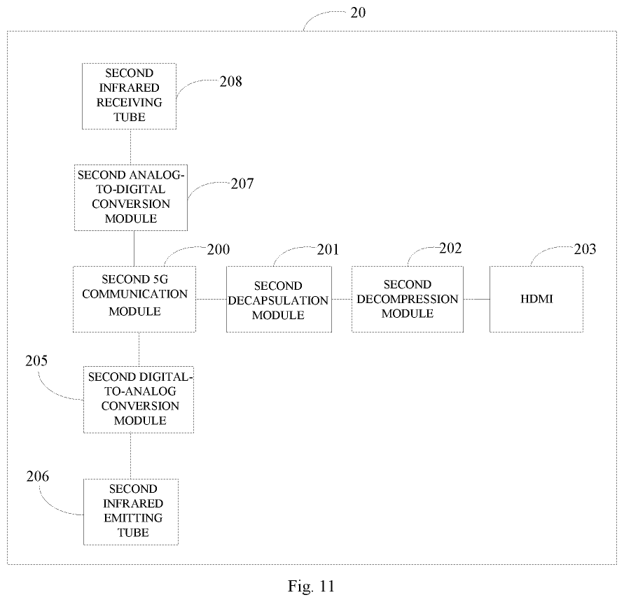

FIG. 11 is another schematic structural diagram of receiving device for multimedia data according to the present application. As shown in FIG. 11, in addition to including the second 5G communication module 200, the second decapsulation module 201, the second decompression module 202, and the HDMI 203, the receiving device 20 may further include the second digital-to-analog conversion module 205, the second infrared emitting tube 206, the second infrared receiving tube 208, and the second analog-to-digital conversion module 207.

It can be understood that related definitions and descriptions not provided in the embodiment of FIG. 11 and specific implementations of the functional components included in the receiving device 20 of FIG. 11 can be referred to the embodiments of FIG. 9 and FIG. 10, which will not be repeated herein.

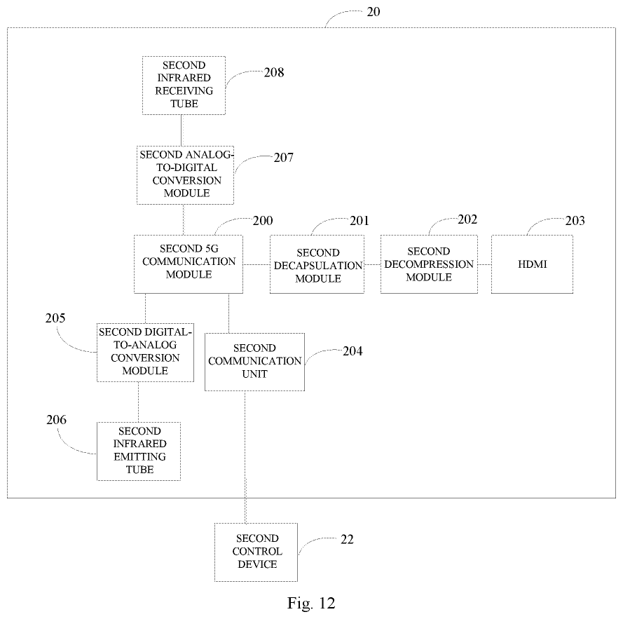

FIG. 12 is another schematic structural diagram of receiving device for multimedia data according to the present application. As shown in FIG. 12, in addition to including the second 5G communication module 200, the second decapsulation module 201, the second decompression module 202, and the HDMI 203, the receiving device 20 may further include the second digital-to-analog conversion module 205, the second infrared emitting tube 206, the second infrared receiving tube 208, the second analog-to-digital conversion module 207, and the second communication unit 204.

It can be understood that related definitions and descriptions not provided in implementations of FIG. 12 and specific implementations of functional components included in the receiving device 20 of FIG. 12 can be referred to implementations described in FIGS. 7-11, which will not be repeated herein.

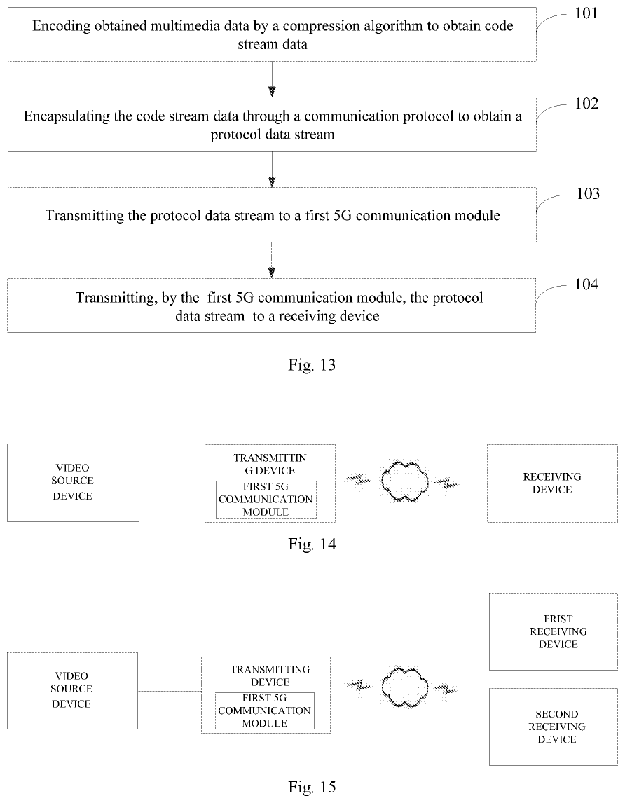

FIG. 13 is a schematic diagram of a transmitting method for multimedia data according to the disclosure. As shown in FIG. 13, the method may include, but is not limited to, the following steps.

At block 101, multimedia data obtained is encoded by a compression algorithm to obtain code stream data.

According to implementations of the disclosure, encoding multimedia data obtained by a compression algorithm to obtain code stream data, which may include, but is not limited to, the following processes.

In process 1, a transmitting device may obtain, through a HDMI, multimedia data from a video source device (such as a DVD, a set-top box, a camera, or a notebook computer).

The multimedia data may include, but is not limited to, perception media data such as text, data, sound, graphics, images, or videos (such as 1080P, 4K or 8K resolution, high-definition video with frame rate 60FPS), representation media data such as telegram code or barcode etc. It should be noted that the multimedia data includes one or more different types of video source data (such as surveillance video, promotional video, cartoon, costume drama or modern urban drama), which are not limited in implementations of the disclosure. The multimedia data may further include, but is not limited to, the following characteristics: a sampling format of YUV/YCbCr with 4:4:4, and High Dynamic Range Imaging (HDR).

In process 2, the transmitting device encodes the multimedia data with a compression algorithm to obtain code stream data, which may include, but is not limited to, the following

Method 1: the transmitting device encodes the multimedia data with a Display Stream Compression (DSC) algorithm to obtain the code stream data.

Method 2: the transmitting device encodes the multimedia data by a JPEG2000 compression algorithm to obtain the code stream data.

In the following, the transmitting device encoding the multimedia data with the DSC algorithm to obtain the code stream data is taken as an example to describe the transmitting method for multimedia data in detail.

In the following, the multimedia data being a video is taken as an example. The transmitting device encodes the video with the DSC algorithm, which may include, but is not limited to, the following.

In step 1, the transmitting device divides each frame image of the video into several non-overlapping square bars as independent coding units. The coding is performed on a line scanning manner. A×1 pixel groups composed of A pixel can be a processing unit, where any one of A pixel is connected. Optionally, A can be 3, 4, or 5, which is not limited herein.

In step 2, the transmitting device uses the DSC algorithm to predict the current pixel based on the intra-differential pulse code modulation (DPCM) method. The prediction residual value is quantized and reconstructed by using a simple integer power quantization of 2. The quantized residual signal is subjected to entropy coding (such as Variable Length Coding (VLC)), where the entropy coding operates on a 3×1 pixel group, and each component can generate an entropy-coded sub-code stream. These sub-code streams (that is, each sub-code stream may be a compressed data stream formed by each component) are packed, stream-multiplexed, and outputted.

It should be noted that the DSC algorithm can support, but not limited to, the following prediction modes: modified median adaptive prediction (MMAP), block prediction (BP), and mid-point prediction (MPP).

It should be noted that the transmitting device transmits media data with 4K resolution and 60 frames per second, and the required transmission bandwidth is required approximately 18 Gbit/s. If the transmitting device compresses the media data with twice, then the transmission bandwidth required for transmitting the media data can be half of the original bandwidth (9 Gbit/s), so the transmission data being compressed by the DSC algorithm can greatly reduce the transmission bandwidth, which correspondingly reduce the transmission cost.

The transmitting device converts code stream data with a YUV444 format into code stream data with a YUV422 format through the CSC, so that the data amount of the code stream data with the YUV422 format is ⅔ of the data amount of the code stream data with the YUV444 format into code stream data.

It should be noted that data with the YUV444 format indicates that each Y component corresponds to a set of UV components, and data with the YUV422 format indicates that every two Y components correspond to (share) a set of UV components. In summary, by converting the data with the YUV444 format into the data with the YUV422 format, the data amount of the data with YUV422 format is ⅔ of the data amount of the data with the YUV444 format.

It should be noted that the transmitting device encoding code stream data with a YUV422 format into code stream data with a YUV420 format can realize ¼ times the lossless compression of the code stream data.

It should be noted that data with the YUV422 format indicates that every two Y components correspond to (share) a set of UV components, and data with a YUV420 format indicates that every four Y components can correspond to (share) a set of UV components. In summary, the transmitting device converts the data with the YUV422 format into the data with the YUV420 format, which can make the data amount of the data with the YUV420 format is ¾ of the data with the YUV422 format.

According to implementations of the disclosure, in addition to encoding the multimedia data according to any one of the foregoing methods to obtain the code stream data, when a format of the multimedia data is a RGB format, the transmitting device converts, through the CSC, the multimedia data with the RGB format into the multimedia data with a YUV444 format, samples the multimedia data with the YUV444 format to obtain the first data with the YUV format, and compresses, with the DSC, the first data to obtain the code stream data.

When a format of the multimedia data is the RGB format, the transmitting device converts, through the CSC, the multimedia data with the RGB format into the multimedia data with the YUV444data format, samples the multimedia data with the YUV444 format of to obtain the first data with the YUV format, and compresses, with the JPEG2000 compression algorithm, the first data to obtain the code stream data.

Specifically, assuming that the multimedia data is the data with format of YUV444, the data with format of YUV444 is first converted into data with a format of YUV422 through the CSC. Then, the data with the format of YUV422 is further compressed through the DSC to obtain code stream data compressed jointly through multiple compression algorithms.

At block 102, the code stream data is encapsulated through a communication protocol to obtain a protocol data stream.

According to implementations of the disclosure, encapsulating the code stream data through a communication protocol to obtain a protocol data stream may include, but is not limited to, the following.

Method 1: the transmitting device encapsulates the code stream data through a user datagram protocol (UDP) to obtain the protocol data stream in the form of a UDP data packet.

It should be noted that the transmitting device may encapsulate the code stream data and a control instruction through the UDP to obtain the protocol data stream in the form of a UDP data packet.

The control instruction may include, but is not limited to, an IR control instruction, a RS232 interface control instruction, a USB interface control instruction, or a universal asynchronous receiver/transmitter (UART) interface control instruction.

Method 2: the transmitting device encapsulates the code stream data through an internet protocol (IP) to obtain the protocol data stream in the form of an IP data packet.

It should be noted that the IP in the implementations of the present application may include the UDP and a transmission control protocol (TCP).

It should be noted that the transmitting device encapsulating the code stream data and the control instruction through the IP communication protocol to obtain the protocol data stream in the form of an IP data packet may include, but is not limited to, the following approaches.

Approach 1: the transmitting device may encapsulate the code stream data through the UDP to obtain a protocol data stream in the form of a UDP data packet, and may encapsulate the control instruction through the TCP protocol to obtain a protocol data stream in the form of a TCP data packet.

Approach 2: the transmitting device may encapsulate the code stream data and the control instruction through the UDP to obtain the protocol data stream in the form of a UDP data packet.

Approach 3: the transmitting device may encapsulate the code stream data and the control instruction through the TCP to obtain a protocol data stream in the form of a TCP data packet.

Method 3: the transmitting device encapsulates the code stream data through a specific communication protocol to obtain the protocol data stream in the form of a specific data packet. The specific communication protocol may include a communication protocol customized according to specific needs.

It should be noted that the transmitting device may encapsulate the code stream data and the control instruction through a specific communication protocol to obtain the protocol data stream in the form of a specific data packet.

At block 103, the protocol data stream is transmitted to a first 5G communication module.

Specifically, the transmitting device may transmit the protocol data stream to the first 5G communication module via a communication interface of the first 5G communication module. It should be noted that the communication interface of the first 5G communication module may include, but is not limited to, a PCIE interface, a Gigabit Ethernet interface, a 10G Ethernet interface, or a USB 3.0 interface, and the like.

According to implementations of the disclosure, the transmitting device may transmit the protocol data stream encapsulated to the first 5G communication module integrated inside the transmitting device.

It should be noted that the first 5G communication module may be a 5G communication module that integrates several antennas. In other words, the first 5G communication module may be a 5G communication module in which several antennas are disposed through antenna in package (AIP) technology and large-scale multi-input multi-output (MIMO) technology, which can increase the transmission rate of the protocol stream data and reduce the transmission delay.

In addition, the first 5G communication module optimizes the structural design of the wireless frame. That is, the format of the protocol data stream inputted to the first 5G communication module is designed. That is, the transmission time interval (TTI) is reduced.

In addition, a channel coding technology with the form of convolutional code coding is also applied to the first 5G communication module.

In summary, it can be known that the transmission rate of multimedia data in the implementations of this application can be improved through Aip technology for the multi-antenna layout, the optimized design of the data frame format, and the channel coding technology in the form of convolutional code coding.

At block 104, the transmitting device transmits, by the first 5G communication module, the protocol data stream to a receiving device, where the receiving device is any one receiving device in the receiving device of the present application.

The purpose of the first 5G communication module is explained in the following four scenarios.

Scenario 1:

This scenario includes a transmitting device and a receiving device.

A first 5G communication module in the transmitting device may be configured to transmit received protocol data stream to the receiving device. That is to say, the transmitting device transmits the protocol data stream received to the receiving device via the first 5G communication module.

The scenario 1 is described briefly in the following with reference to FIG. 14. As shown in FIG. 14, the transmitting device transmits, by the first 5G communication module, the protocol data stream received to the receiving device based on a network. It should be noted that the transmitting device obtains multimedia data from a video source device via a HDMI, compresses and encapsulates the multimedia data to obtain a protocol data stream, and transmits the protocol data stream to the first 5G communication module.

Scenario 2:

This scenario may include, but is not limited to, a transmitting device, a first receiving device, and a second receiving device.

A first 5G communication module in the transmitting device may be configured to:

transmit a protocol data stream to the first receiving device and the second receiving device, respectively.

That is, the transmitting device transmits, by the first 5G communication module, the protocol data stream to the first receiving device and the second receiving device, respectively.

In summary, a first display device connected to the first receiving device and a second display device connected to the second receiving device can respectively display a high-definition video corresponding to the protocol data stream.

The scenario 2 is described briefly in the following with reference to FIG. 15. As shown in FIG. 15, the transmitting device transmits, by the first 5G communication module, the protocol data stream received to the first receiving device and the second receiving device based on a network.

Scenario 3:

This scenario may include, but is not limited to: a transmitting device, a base station, and a receiving device.

A first 5G communication module in the transmitting device is configured to:

transmit a protocol data stream to the base station, and forward, by the base station, the protocol data stream to the receiving device.

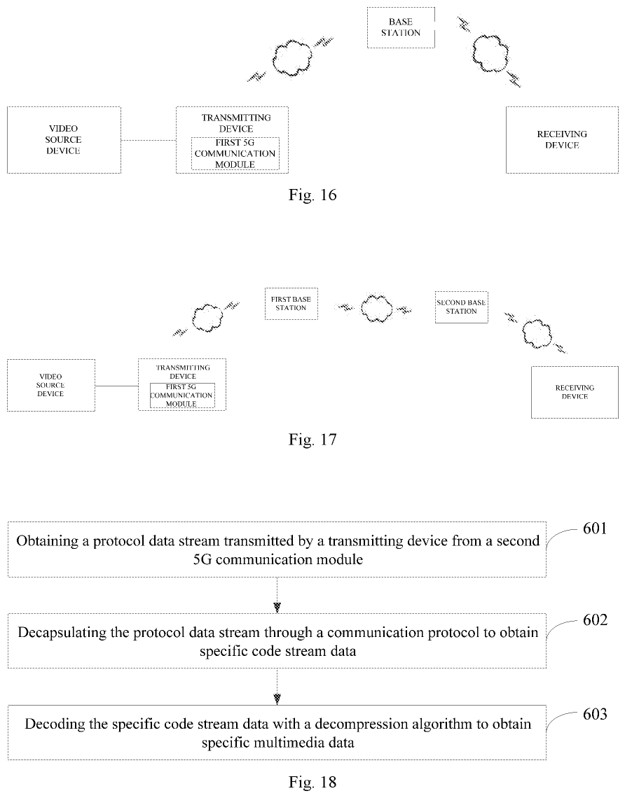

The scenario 3 is described briefly below with reference to FIG. 16. As shown in FIG. 16, the transmitting device transmits, by the first 5G communication module, the protocol data stream received to the base station based on a network, and forwards, by the base station based on the network, the protocol data stream to the receiving device.

Scenario 4:

This scenario may include, but is not limited to, a transmitting device, a first base station, a second base station, and a receiving device.

A first 5G communication module in the transmitting device is configured to:

transmit a protocol data stream to the first base station, forward, by the first base station, the protocol data stream to the second base station, and transmit, by the second base station, the protocol data stream to the receiving device.

The following describes the scenario 4 briefly with reference to FIG. 17. As shown in FIG. 17, the transmitting device transmits, by the first 5G communication module, the received protocol data stream to the first base station based on a network, the first base station transmits the protocol data stream to the second base station through the network, and the second base station transmits the protocol data stream to the receiving device through the network.

It should be noted that FIGS. 14-17 are only intended to explain implementations of the disclosure, and no limitation should be imposed on the disclosure.

According to implementations of the disclosure, the transmitting method for multimedia data is provided. The multimedia data obtained is encoded through the compression algorithm to obtain the code stream data. The code stream data is encapsulated through the communication protocol to obtain the protocol data stream. The protocol data stream is transmitted to a first 5G communication module. The first 5G communication module may be configured to transmit the protocol data stream to a receiving device.

In summary, it can be known that, according to implementations of the disclosure, on one hand, can reduce the wiring cost of transmission for multimedia data, on the other hand, and can increase the transmission rate of multimedia data.

FIG. 18 is a schematic flow chart of a receiving method for multimedia data according to implementations of the disclosure. As shown in FIG. 18, the method may include at least the following steps.

At block 601, a protocol data stream transmitted by a transmitting device is obtained from a second 5G communication module. The transmitting device is any transmitting device in the present application.

Specifically, a receiving device may obtain, via a communication interface of the second 5G communication module, the foregoing protocol data stream from the second 5G communication module.

It should be noted that the communication interface of the second 5G communication module may include, but is not limited to, a PCIE interface, a Gigabit Ethernet interface, a 10G Ethernet interface, or a USB 3.0 interface, and the like.

According to implementations of the disclosure, the receiving device may obtain the protocol data stream from the second 5G communication module integrated into the receiving device. The second 5G communication module may be a 5G communication module configured with several antennas.

It should be noted that the second 5G communication module adopts a design method of high-reliability and low-latency communication.

Specifically, by using a channel decoding technology in the form of a convolutional code, the protocol data stream received through the multiple antennas encapsulated with the AIP technology is decoded at the first time to make data processing time shorter. Then, the receiving device decapsulates the protocol data stream decoded to obtain a specific code stream and decompresses the specific code stream to obtain specific multimedia data corresponding to the protocol data stream. It should be noted that a display device connected to the receiving device can display the specific multimedia data without delay.

The purpose of the second 5G communication module is explained in the following four scenarios.

Scenario 5: This scenario includes a transmitting device and a receiving device.

A second 5G communication module in the receiving device may be configured to receive a protocol data stream from the transmitting device.

That is, the receiving device receives the protocol data stream from the transmitting device by the second 5G communication module.

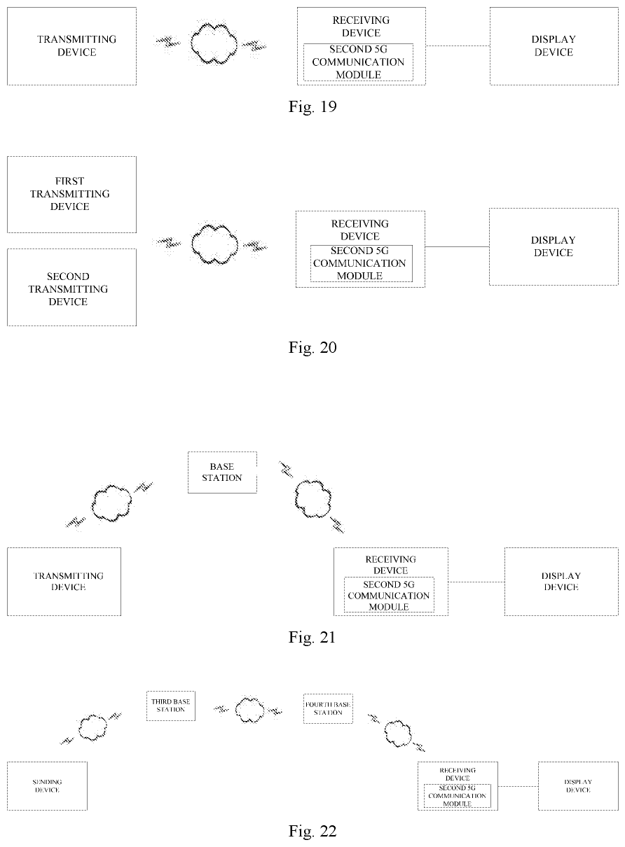

The following describes a scenario 5 d briefly with reference to FIG. 19. As shown in FIG. 19, the receiving device receives, by the second 5G communication module, the protocol data stream from the transmitting device based on a network.

In summary, it can be known that after decapsulating the protocol stream to obtain a specific code stream and decompressing the specific code stream to obtain the specific multimedia data corresponding to the protocol data stream. It should be noted that a display device connected to the receiving device can display the specific multimedia data without delay.

Scenario 6: the transmitting device includes a first transmitting device and a second transmitting device.

The protocol data stream includes a first protocol data stream and a second protocol data stream.

The second 5G communication module may be configured to:

receive the first protocol data stream from the first transmitting device, and receive the second protocol data stream from the second transmitting device.

That is, the receiving device may receive the first protocol data stream from the first transmitting device and receive the second protocol data stream from the second transmitting device by the second 5G communication module respectively.

In summary, the receiving device decapsulates the protocol data stream decoded to obtain the specific code stream and decompresses the specific code stream to obtain specific multimedia data corresponding to the protocol data stream. It should be noted that the display device connected to the receiving device can display the first specific multimedia data and the second specific multimedia data through spitted screens.

The following describes scenario 6 briefly with reference to FIG. 20. As shown in FIG. 20, the receiving device may receive the first protocol data stream from the first transmitting device and receive the second protocol data stream from the second transmitting device by the second 5G communication module respectively.

Scenario 7: the second 5G communication module is configured to execute as follows.

The receiving devices receive a protocol data stream forwarded by the base station, where the protocol data is received, by the base station, from a transmitting device.

The following describes scenario 7 briefly with reference to FIG. 21. As shown in FIG. 21, the receiving device receives a protocol data stream forwarded by the base station, where the protocol data is received, by the base station, from a transmitting device.

Scenario 8: the base station includes a third base station and a fourth base station.

The second 5G communication module is specifically configured to execute as follows.

The receiving device receives the protocol data stream forwarded by the fourth base station, after the third base station receives a protocol data stream transmitted by a transmitting device and forwards the protocol data stream to the fourth base station.

The following describes the scenario 4 briefly with reference to FIG. 22. As shown in FIG. 22, the third base station receives a protocol data stream transmitted by a transmitting device and forwards the protocol data stream to the fourth base station.

At block 602, the protocol data stream is decapsulated through a communication protocol to obtain specific code stream data.

According to implementations of the disclosure, the protocol data stream is decapsulated through a communication protocol to obtain specific code stream data may include, but is not limited to, the following methods.

Method 1: if the protocol data stream is a protocol data stream in the form of a user datagram protocol (UDP) data packet, the receiving device may decapsulate the foregoing protocol data stream through a UDP to obtain the specific code stream data.

It should be noted that the receiving device may decapsulate the above protocol data stream through the UDP to obtain a control instruction, which may be configured to control a display device connected to the receiving device (such as the startup or shutdown of the display device).

Method 2: if the protocol data stream is a protocol data stream in the form of an internet protocol (IP) data packet, the receiving device may decapsulate the foregoing protocol data stream through an IP to obtain the specific code stream data.

It should be noted that the receiving device may decapsulate the protocol data stream through the IP to obtain a control instruction, where the function of the control instruction will not be repeated in here.

Method 3: if the protocol data stream is a protocol data stream with the form of a specific data packet, the receiving device may decapsulate the protocol data stream through a specific communication protocol to obtain the specific code stream data.

It should be noted that the receiving device may decapsulate the foregoing protocol data stream through a specific communication protocol to obtain a control instruction.

At block 603, the specific code stream data is decoded with a decompression algorithm to obtain specific multimedia data.

According to implementations of the disclosure, if the transmitting device encodes the multimedia data with a display stream compression (DSC) algorithm to obtain code stream data, the receiving device may decode the specific code stream data with a DSC decompression algorithm to obtain specific multimedia data.

The DSC decompression algorithm is taken as an example to briefly explain how to decode specific code stream data to obtain specific multimedia data.

Specifically, after the receiving device buffers the decapsulated specific code stream data, the receiving device can extract information such as residuals, encoding modes, and the like from the component code stream through variable length decoding (VLD), extract a prediction value from the previously obtained encoding mode information, and dequantize the residual to be added to the prediction value to obtain the set of pixel values of the reconstructed image, so as to realize the purpose of generating the data of the frame image (specific multimedia data).

If the transmitting device encodes the multimedia data with a JPEG2000 compression algorithm to obtain code stream data, the receiving device may decode the specific code stream data with a JPEG2000 decompression algorithm to obtain specific multimedia data.

It should be noted that when a format of the specific multimedia data is a RGB format, the specific stream data is decompressed, with the DSC decompression algorithm, to obtain the first specific data with the YUV format. The first specific data is interpolated to obtain the specific multimedia data with the YUV444 format. The specific multimedia data with the YUV444 format is converted, with a color space converter (CSC), into the specific multimedia data with the RGB format.

It should be noted that when the format of the specific multimedia data is with the RGB format, the specific stream data is decompressed, with the JPEG2000 decompression algorithm, to obtain the first specific data with the YUV format. The first specific data is interpolated to obtain the specific multimedia data with the YUV444 format. The specific multimedia data with the YUV444 format is converted, with the CSC, into the specific multimedia data with the RGB format.

It should be noted that FIGS. 19-22 are only intended to explain the implementations of the disclosure, and no limitation should be imposed on the disclosure.

According to implementations of the disclosure, the receiving method for the multimedia data is provided. Firstly, the protocol data stream is obtained from a second 5G communication module. Then, the protocol data stream is decapsulated through a communication protocol to obtain specific code stream data. Finally, the specific code stream data is decoded with decompression algorithm to obtain specific multimedia data. The display device connected to a receiving device displays the specific multimedia data without delay. On one hand, the wiring cost required for transmission can be saved, on the other hand, the transmission rate of the multimedia data can be increased, so as to realize the delay-free playback of the multimedia data.

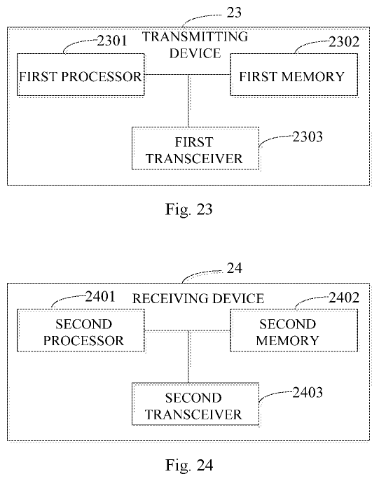

FIG. 23 is another schematic structural diagram of a transmitting device for multimedia data according to the present application. As shown in FIG. 23, the transmitting device 23 may include, but is not limited to, a first processor 2301, a first memory 2302, and a first transceiver 2303. The first processor 2301, the first memory 2302, and the first transceiver 2303 are connected through cables respectively.

The first transceiver 2303 is configured to obtain multimedia data.

The multimedia data may include, but is not limited to, perception media data such as text, data, sound, graphics, images, or videos (such as 1080P, 4K or 8K resolution, high-definition video with frame rate 60FPS), representation media data such as telegram code or bar code etc. It should be noted that the multimedia data includes one or more different types of video source data (such as surveillance video, promotional video, cartoon, costume drama or modern urban drama), which are not limited in the embodiments of the present application. The multimedia data may further include, but is not limited to, the following characteristics: a sampling format of YUV/YCbCr with 4:4:4, and HDR.

The first memory 2302 is configured to store the multimedia data obtained.

The first processor 2301 is configured to compress the multimedia data, with a compression algorithm, to obtain code stream data.

The first processor 2301 may specifically execute the following methods.

Method 1: the multimedia data is encoded, with a DSC algorithm, to obtain the code stream data.

Method 2: the multimedia data is encoded, with a JPEG2000 compression algorithm, to obtain the code stream data.

In the following, the multimedia data being a video is taken as an example. The first processor 2301 is configured to encode the video with the DSC algorithm, which may include, but is not limited to, the following steps.

In step 1, the first processor 2301 is configured to divide each frame image in the video into several non-overlapping square bars as independent coding units. The coding is performed in a line scanning manner. A×1 pixel groups composed of A pixel can be a processing unit, where any one of A pixel is connected. Optionally, A can be 3, 4, or 5, which is not limited herein.

In step 2, the first processor 2301 is configured to use the DSC algorithm to predict the current pixel based on the intra-differential pulse code modulation (DPCM) method. The prediction residual value is quantized and reconstructed by using a simple integer power quantization of 2. The quantized residual signal is subjected to entropy coding (such as variable length coding (VLC)), where the entropy coding operates on a 3×1 pixel group, and each component can generate an entropy-coded sub-code stream. These sub-code streams (that is, each sub-code stream may be a compressed data stream formed by each component) are packed, stream-multiplexed, and outputted.

It should be noted that the DSC algorithm can support, but not limited to, the following prediction modes: MMAP, BP, and MPP.

The first processor 2301 is further configured to convert, with the CSC, code stream data with a YUV444 format into code stream data with a YUV422 format, so that the data amount of the code stream data with the YUV422 format is ⅔ of the data amount of the code stream data with the YUV444 format into code stream data.

It should be noted that data with the YUV444 format indicates that each Y component corresponds to a set of UV components, and data with the YUV422 format indicates that every two Y components correspond to (share) a set of UV components. In summary, the first processor 2301 is configured to convert the data with the YUV444 format into the data with YUV422 format, the data amount of the data with YUV422 format is ⅔ of the data amount of the data with the YUV444 format.

It should be noted that the first processor 2301 being configured to encode code stream data with a YUV422 format into code stream data with a YUV420 format can realize ¼ times the lossless compression of the code stream data.

It should be noted that data with the YUV422 format indicates that every two Y components correspond to (share) a set of UV components, and data with a YUV420 format indicates that every four Y components can correspond to (share) a set of UV components. In summary, the first processor 2301 converts the data with the YUV422 format into the data with the YUV420 format, which can make the data amount of the data with the YUV420 format is ¾ of the data with the YUV422 format.

According to implementations of the disclosure, in addition to encoding the multimedia data according to any one of the foregoing methods to obtain the code stream data, when a data format of the multimedia data is a RGB format, the first processor is configured to convert, through the CSC, the multimedia data with the RGB format into the multimedia data with a YUV444 format, sample the multimedia data with the YUV444 format to obtain the first data with the YUV format, and compress, with the DSC, the first data to obtain the code stream data.

When a format of the multimedia data is the RGB format, the first processor 2301 configured to convert, through the CSC, the multimedia data with the RGB format into the multimedia data with the YUV444 data format, sample the multimedia data with the YUV444 format of to obtain the first data with the YUV format, and compress, with the JPEG2000 compression algorithm, the first data to obtain the code stream data.

The first processor 2301 is configured to encapsulate the code stream data through a communication protocol to obtain a protocol data stream.

The first processor 2301 is configured to execute the following methods.

Method 1: the first processor 2301 is configured to encapsulate the code stream data through a user datagram protocol (UDP) to obtain the protocol data stream in the form of an UDP data packet.

It should be noted that the first processor 2301 is configured to encapsulate the code stream data and a control instruction through the UDP to obtain the protocol data stream in the form of a UDP data packet.

The control instruction may include, but is not limited to, an IR control instruction, a RS232 interface control instruction, an USB interface control instruction, or an UART interface control instruction.

Method 2: the first processor 2301 is configured to encapsulate the code stream data through an IP communication protocol to obtain the protocol data stream in the form of an IP data packet.

It should be noted that the IP in implementations of the disclosure may include the UDP and a transmission control protocol (TCP).

It should be noted that the first processor 2301 is configured to encapsulate the code stream data and the control instruction through the IP communication protocol to obtain the protocol data stream in the form of an IP data packet may include but is not limited to the following approaches.

Approach 1: the first processor 2301 is configured to encapsulate the code stream data through the UDP to obtain a protocol data stream in the form of a UDP data packet, and may encapsulate the control instruction through the TCP to obtain a protocol data stream in the form of a TCP data packet.

Approach 2: the first processor 2301 is configured to encapsulate the code stream data and the control instruction through the UDP to obtain the protocol data stream in the form of a UDP data packet.

Approach 3: the first processor 2301 is configured to encapsulate the code stream data and the control instruction through the TCP to obtain a protocol data stream in the form of a TCP data packet.

Method 3: the first processor 2301 is configured to encapsulate the code stream data through a specific communication protocol to obtain the protocol data stream in the form of a specific data packet. The specific communication protocol may include a communication protocol customized according to specific needs.

It should be noted that the first processor 2301 is configured to encapsulate the code stream data and the control instruction through a specific communication protocol to obtain the protocol data stream with the form of a specific data packet.

The first processor 2301 is further configured to transmit the protocol data stream to a first 5G communication module.

Specifically, the first transceiver 2303 is configured to transmit the protocol data stream to the first 5G communication module through a communication interface of the first 5G communication module. It should be noted that the communication interface of the first 5G communication module may include, but is not limited to, a PCIE interface, a Gigabit Ethernet interface, a 10G Ethernet interface, or an USB 3.0 interface, and the like.

According to implementations of the disclosure, the first transceiver 2303 is further configured to transmit the protocol data stream encapsulated to the first 5G communication module integrated inside the transmitting device.

It should be noted that the first 5G communication module may be a 5G communication module that integrates several antennas. In other words, the first 5G communication module may be a 5G communication module in which several antennas are disposed through AIP technology and large-scale MIMO technology, which can increase the transmission rate of the protocol stream data and reduce the transmission delay.

In addition, the first 5G communication module optimizes the structural design of the wireless frame. That is, the data format of the protocol data stream inputted to the first 5G communication module is designed. That is, the TTI is reduced.

In addition, a channel coding technology with the form of convolutional code coding is also applied to the first 5G communication module.

In summary, it can be known that the transmission rate of multimedia data in the implementations of this application can be improved through AIP technology for the multi-antenna layout, the optimized design of the data frame format, and the channel coding technology in the form of convolutional code coding.

The first 5G communication module is configured to transmit the protocol data stream to a receiving device, where the receiving device is any one receiving device in the receiving device of the disclosure.

The purpose of the first 5G communication module is explained in the following four scenarios.

Scenario 1: this scenario includes a transmitting device and a receiving device.

A first 5G communication module in the transmitting device may be configured to transmit received protocol data stream to the receiving device. That is to say, the transmitting device transmits the protocol data stream received to the receiving device by the first 5G communication module.

Scenario 2: this scenario may include, but is not limited to, a transmitting device, a first receiving device, and a second receiving device.

A first 5G communication module in the transmitting device may be configured to:

transmit a protocol data stream to the first receiving device and the second receiving device, respectively.

That is, the transmitting device transmits, by the first 5G communication module, the protocol data stream to the first receiving device and the second receiving device, respectively.

In summary, a first display device connected to the first receiving device and a second display device connected to the second receiving device can respectively display a high-definition video corresponding to the protocol data stream.

Scenario 3: this scenario may include, but is not limited to: a transmitting device, a base station, and a receiving device.

A first 5G communication module in the transmitting device is configured to:

transmit a protocol data stream to the base station, and forward, by the base station, the protocol data stream to the receiving device.

Scenario 4: this scenario may include, but is not limited to, a transmitting device, a first base station, a second base station, and a receiving device.

A first 5G communication module in the transmitting device is configured to:

transmit a protocol data stream to the first base station, forward, by the first base station, the protocol data stream to the second base station, and transmit, by the second base station, the protocol data stream to the receiving device.

FIG. 24 is another schematic structural diagram of a receiving device for multimedia data according to the present application. As shown in FIG. 24, the transmitting device 24 may include, but is not limited to, a second processor 2401, a second memory 2402, and a second transceiver 2403. The second processor 2401, the second memory 2402, and the second transceiver 2403 are connected through cables respectively.

The second transceiver 2403 is configured to receive a protocol data stream transmitted by a transmitting device. The transmitting device is any one of transmitting device in the disclosure.

The second memory 2402 is configured to store the protocol data stream.

The second transceiver 2403 is specifically configured to obtain, through a communication interface of the second 5G communication module, the foregoing protocol data stream from the second 5G communication module.

It should be noted that the communication interface of the second 5G communication module may include, but is not limited to, a PCIE interface, a Gigabit Ethernet interface, a 10G Ethernet interface, or an USB 3.0 interface, and the like.

The second 5G communication module may be a 5G communication module configured with several antennas.

It should be noted that the second 5G communication module adopts a design method of high-reliability and low-latency communication.

By using a channel decoding technology in the form of a convolutional code, the protocol data stream received through the multiple antennas encapsulated with the AIP technology is decoded at the first time to make data processing time shorter. then, the receiving device decapsulates the protocol data stream decoded to obtain a specific code stream and decompresses the specific code stream to obtain specific multimedia data corresponding to the protocol data stream. It should be noted that a display device connected to the receiving device can display the specific multimedia data without delay.

The function of the second 5G communication module is explained in the following four scenarios.

Scenario 5: this scenario includes a transmitting device and a receiving device.

A second 5G communication module in the receiving device may be configured to receive a protocol data stream from the transmitting device.

That is, the receiving device receives the protocol data stream from the transmitting device by the second 5G communication module.

Scenario 6: the transmitting device includes a first transmitting device and a second transmitting device.

The protocol data stream includes a first protocol data stream and a second protocol data stream.

The second 5G communication module may be configured to:

receive the first protocol data stream from the first transmitting device, and receive the second protocol data stream from the second transmitting device.

That is, the receiving device may receive the first protocol data stream from the first transmitting device and receive the second protocol data stream from the second transmitting device by the second 5G communication module respectively.

Scenario 7: the second 5G communication module is configured to execute as follows.

The receiving device receives a protocol data stream forwarded by the base station, where the protocol data is received, by the base station, from a transmitting device.

Scenario 8: the base station includes a third base station and a fourth base station.

The second 5G communication module is specifically configured to execute as follows.

The receiving device receive, the second 5G communication module, the protocol data stream forwarded by the fourth base station, after the third base station receives a protocol data stream transmitted by a transmitting device and forwards the protocol data stream to the fourth base station.

The second processor 2401 is configured to execute the following methods.

Method 1: if the protocol data stream is a protocol data stream in the form of a UDP data packet, the second processor 2401 is configured to decapsulate the foregoing protocol data stream through a user datagram protocol (UDP) to obtain the specific code stream data.

It should be noted that the second processor 2401 is configured to decapsulate the above protocol data stream through the UDP to obtain a control instruction, which may be configured to control a display device connected to the receiving device (such as the startup or shutdown of the display device).

Method 2: if the protocol data stream is a protocol data stream with the form of an internet protocol (IP) data packet, the second processor 2401 is configured to decapsulate the foregoing protocol data stream through an IP to obtain the specific code stream data.

It should be noted that the second processor 2401 is configured to decapsulate the protocol data stream through the IP to obtain a control instruction, where the function of the control instruction will not be repeated in this embodiment.

Method 3: if the protocol data stream is a protocol data stream in the form of a specific data packet, the second processor 2401 is configured to decapsulate the protocol data stream through a specific communication protocol to obtain the specific code stream data.

It should be noted that the second processor 2401 is configured to decapsulate the foregoing protocol data stream through a specific communication protocol to obtain a control instruction.

The second processor 2401 is further configured to decode the specific code stream data with a decompression algorithm to obtain specific multimedia data.

According to implementations of the disclosure, if the transmitting device encodes the multimedia data with a DSC algorithm to obtain code stream data, the second processor 2401 is configured to decode the specific code stream data with a DSC decompression algorithm to obtain specific multimedia data.

The DSC decompression algorithm is taken as an example to briefly explain how to decode specific code stream data to obtain specific multimedia data.

After the second memory 2402 is configured to buffers the decapsulated specific code stream data, the second processor 2401 is configured to extract information such as residuals, encoding modes, and the like from the component code stream through variable length decoding (VLD), extract a prediction value from the previously obtained encoding mode information, and dequantize the residual to be added to the prediction value to obtain the set of pixel values of the reconstructed image, so as to realize the purpose of generating the data of the frame image (specific multimedia data).

If the transmitting device encodes the multimedia data with a JPEG2000 compression algorithm to obtain code stream data, the second processor 2401 is configured to decode the specific code stream data with a JPEG2000 decompression algorithm to obtain specific multimedia data.

It should be noted that when a format of the specific multimedia data is the format of the RGB data, the second processor 2401 is configured to decompress the specific stream data, with the DSC decompression algorithm, to obtain the first specific data with the format of YUV data, interpolate the first specific data to obtain the specific multimedia data with the YUV444 format, and convert the specific multimedia data with the YUV444 format, with the CSC, into the specific multimedia data with the RGB format.

It should be noted that when a format of the specific multimedia data is the RGB format, the second processor 2401 is configured to decompress the specific stream data, with the JPEG2000 decompression algorithm, to obtain the first specific data with the YUV format, interpolate the first specific data to obtain the specific multimedia data with the YUV444 format, and convert the specific multimedia data with the YUV444 format, with a CSC algorithm, into the specific multimedia data with the RGB format.

Those of ordinary skill in the art may realize that the modules and algorithm steps of each example described in this application can be implemented by electronic hardware, computer software, or a combination thereof. In order to clearly explain the interchangeability of hardware and software, the composition and steps of each example have been described generally in terms of functions in the above description. Whether these functions are performed on hardware or software depends on the specific application and design constraints of the technical solution. Professional technicians can use different methods to implement the described functions for each specific application, but such implementation should not be considered to be beyond the scope of this application.

Those skilled in the art can clearly understand that, for the convenience and brevity of the description, the specific working processes of the devices and modules described above can refer to the corresponding processes in the foregoing embodiments of the method, and are not repeated herein.

The device implementations described above are only schematic. For example, the division of the modules is only a logical function division. In actual implementation, there may be another division manner. For example, multiple modules or components may be combined or integrated into another device, or some features can be ignored or not be implemented. In addition, the displayed or discussed mutual coupling or direct coupling or communication connection may be indirect coupling or communication connection through some interfaces, equipment, devices or modules, and may also be electrical, mechanical or other forms of connection.

The modules described as separate components may or may not be physically separated, and the components displayed as modules may or may not be physical modules, may be located in one place, or may be distributed on multiple network modules. Some or all of the modules may be selected according to actual needs to achieve the objects of the solutions in the embodiments of the present application.

In addition, each functional module in each embodiment of the present application may be integrated into one processing module, or each module may exist separately physically, or two or more modules may be integrated into one module. The above integrated modules may be implemented on the form of hardware or software functional modules.

When the integrated module is implemented on the form of a software functional module and sold or used as an independent product, it can be stored in a computer-readable storage medium. Based on this understanding, the technical solution of this application essentially or a part that contributes to the existing technology, or all or part of the technical solution may be embodied on the form of a software product. The computer software product is stored in a storage medium which includes instructions to enable a computer device (which may be a personal computer, a server, or a network device, etc.) to perform all or part of the steps of the method described in the embodiments of the present application. The foregoing storage media include: U-disks, mobile hard disks, read-only memory (ROM), random access memory (RAM), magnetic disks, or optical disks and other media that can store program codes.

The above is only a specific implementation of this application, but the scope of protection of this application is not limited to this. Any person skilled in the art can easily think of various equivalent modifications or replacements within the technical scope disclosed in this application which should be covered by the protection scope of this application. Therefore, the protection scope of this application shall be subject to the protection scope of the claims.

What is claimed is:

1. A transmitting device for multimedia data, comprising:
a high definition multimedia interface (HDMI) configured to obtain multimedia data;
a first compression module coupled with the HDMI configured to compress the multimedia data to obtain code stream data;
a first encapsulation module coupled with the first compression module configured to encapsulate the code stream data through a communication protocol to obtain a protocol data stream; and
a first 5th-Generation (5G) communication module coupled with the first encapsulation module configured to transmit the protocol data stream.

2. The transmitting device according to claim 1, wherein the first 5G communication module is communicatively connected to a receiving device or is communicatively connected to a base station.

3. The transmitting device according to claim 1, further comprising:
a first communication unit coupled with a first control device, the first communication unit being connected to the first encapsulation module, wherein
the first encapsulation module configured to encapsulate the code stream data through a communication protocol to obtain a protocol data stream is configured to encapsulate a control instruction and the code stream data to obtain the protocol data stream, wherein the control instruction is obtained from the first control device by the first communication unit.

4. The transmitting device according to claim 1, further comprising:
a first infrared receiving tube; and
a first analog-to-digital conversion module configured to perform analog-to-digital conversion on a first signal received by the first infrared receiving tube to obtain a first digital signal; wherein
the first encapsulation module configured to encapsulate the code stream data through a communication protocol to obtain a protocol data stream is configured to encapsulate the first digital signal and the code stream data to obtain the protocol data stream.

5. The transmitting device according to claim 1, further comprising:
a first infrared emitting tube;
a first decapsulation module configured to decapsulate the protocol data stream received from the receiving device by the first 5G communication module to obtain a second digital signal; and
a first digital-to-analog conversion module configured to convert the second digital signal to obtain a second analog signal according to which the transmitting device controls the first infrared emitting tube to emit a second signal.

6. A receiving device for multimedia data, comprising:
a second 5th-Generation (5G) communication module configured to receive a protocol data stream;
a second decapsulation module coupled with the second 5G communication module configured to decapsulate the protocol data stream from the second 5G communication module to obtain specific code stream data;
a second decompression module coupled with the second decapsulation module configured to decompress the specific code stream data to obtain specific multimedia data; and
a high definition multimedia interface (HDMI) coupled with the second decompression module configured to output the specific multimedia data.

7. The receiving device according to claim 6, wherein:
the second 5G communication module is communicatively connected to a transmitting device or a base station.

8. The receiving device according to claim 6, further comprising:
a second communication unit coupled with a second control device; and
a second encapsulation module coupled with the second communication unit wherein
the second encapsulation module is configured to encapsulate a control instruction obtained from the second control device by the second communication unit to obtain the protocol data stream.

9. The receiving device according to claim 6, further comprising:
a second infrared receiving tube;
a second analog-to-digital conversion module coupled with the second infrared receiving tube configured to perform analog-to-digital conversion on a third signal received by the second infrared receiving tube to obtain a third digital signal; and
a second encapsulation module coupled with the second analog-to-digital conversion module configured to encapsulate the third digital signal to obtain the protocol data stream.

10. The receiving device according to claim 6, wherein
the second decapsulation module configured to decapsulate the protocol data stream from the second 5G communication module to obtain specific code stream data is configured to decapsulate the protocol data stream received from the transmitting device by the second 5G communication module to obtain a fourth digital signal;
the receiving device further comprising:
a second infrared emitting tube;
and a second digital-to-analog conversion module configured to perform digital-to-analog conversion on the fourth digital signal to obtain a fourth analog signal according to which the receiving device controls the second infrared emitting tube to transmit a fourth signal.

11. A transmitting method for multimedia data, comprising:
encoding, with a compression algorithm, multimedia data obtained to obtain code stream data;
encapsulating the code stream data through a communication protocol to obtain a protocol data stream; and
transmitting the protocol data stream to a first 5th-Generation (5G) communication module.

12. The transmitting method according to claim 11, wherein
encoding, with the compression algorithm, multimedia data obtained to obtain code stream data comprises:
encoding, with a display stream compression (DSC) algorithm, the multimedia data obtained to obtain the code stream data; or
encoding, with a JPEG2000 compression algorithm, the multimedia data obtained to obtain the code stream data;
when a format of the multimedia data is a RGB format, converting, with a color space converter (CSC), the multimedia data with the RGB format into the multimedia data with a YUV444 format, sampling the multimedia data with the YUV444 format to obtain first data with the YUV format, and compressing, with the DSC algorithm, the first data to obtain the code stream data; or
when the multimedia data is a RGB format, converting, with the CSC, the multimedia data with the RGB format into the multimedia data with the YUV444 format, sampling the multimedia data with the YUV444 format to obtain the first data with the YUV format, and compressing, with the JPEG2000 compression algorithm, the first data to obtain the code stream data.

13. The transmitting method according to claim 11, wherein:
encapsulating the code stream data through the communication protocol to obtain the protocol data stream comprises:
encapsulating the code stream data through a user datagram protocol (UDP) to obtain the protocol data stream in the form of a UDP data packet;
encapsulating the code stream data through an internet protocol (IP) to obtain the protocol data stream in the form of an IP data packet; or,
encapsulating the code stream data through a specific communication protocol to obtain the protocol data stream in the form of a specific data packet.

14. The transmitting method according to claim 11, further comprising:
transmitting, by the first 5G communication module, the protocol data stream to a receiving device;
the receiving device comprising a first receiving device and a second receiving device;
wherein transmitting, by the first 5G communication module, the protocol data stream to the receiving device comprises:
transmitting, by the first 5G communication module, the protocol data stream to the first receiving device and the second receiving device, respectively.

15. The transmitting method according to claim 11, further comprising:
transmitting, the first 5G communication module, the protocol data stream to a base station, and forwarding the protocol data stream to a receiving device by the base station.

16. A receiving method for multimedia data, comprising:
obtaining a protocol data stream from a second 5th-Generation (5G) communication module;
decapsulating the protocol data stream through a communication protocol to obtain specific code stream data; and
decoding, with a decompression algorithm, the specific code stream data to obtain specific multimedia data.

17. The receiving method according to claim 16, further comprising:
obtaining, by the second 5G communication module, the protocol data stream from a transmitting device;
the transmitting device comprising a first transmitting device and a second transmitting device, and the protocol data stream comprising a first protocol data stream and a second protocol stream;
wherein obtaining, by the second 5G communication module, the protocol data stream from the transmitting device comprises:
receiving, by the second 5G communication module, the first protocol data stream from the first transmitting device, and receiving the second protocol data stream from the second transmitting device, respectively.

18. The receiving method according to claim 16, further comprising:
receiving, the second 5G communication module, the protocol data stream forwarded by a base station; wherein
the protocol data stream is received by the base station from the transmitting device.

19. The receiving method according to claim 16, wherein decapsulating the protocol data stream through the communication protocol to obtain the specific code stream data comprises:
decapsulating, through a user datagram protocol (UDP), the protocol data stream in the form of a UDP data packet to obtain the specific code stream data; or
decapsulating, through an internet protocol (IP), the protocol data stream in the form of an IP data packet to obtain the specific code stream data; or
decapsulating, through a specific communication protocol, the protocol data stream in the form of a specific data packet to obtain the specific code stream data.

20. The receiving method according to claim 16, wherein decoding, with the decompression algorithm, the specific code stream data to obtain the specific multimedia data comprises:
decoding, with a display stream compression (DSC) decompression algorithm, the specific code stream data to obtain the specific multimedia data; or
decoding, with a JPEG2000 decompression algorithm, the specific code stream data to obtain the specific multimedia data; or
when a format of the specific multimedia data is a RGB format, decompressing, with the DSC decompression algorithm, the specific stream data to obtain first specific data with a YUV format, interpolating the first specific data to obtain the specific multimedia data with a YUV444 data format, and converting, with a color space converter (CSC), the specific multimedia data with the YUV444 format into the specific multimedia data with a RGB format; or
when the format of the specific multimedia data is the RGB format, decompressing, with the JPEG2000 decompression algorithm, the specific stream data to obtain the first specific data with the YUV format, interpolating the first specific data to obtain the specific multimedia data with the YUV444 format, and converting, with the CSC, the specific multimedia data with the YUV444 format into the specific multimedia data with the RGB format.
